(19) United States
(12) Patent Application Publication
(10) Pub. No.: US 2026/0145060 A1
(43) Pub. Date: May 28, 2026

(54) HANDHELD ELECTRONIC DEVICE

(71) Applicant: COMPAL ELECTRONICS, INC., Taipei City (TW)

(72) Inventors: Wei-Ru Lin, Taipei City (TW); Kun-Yen Liu, Taipei City (TW); Tzu-Chien Lai, Taipei City (TW); Hung-Yu Yu, Taipei City (TW); Jia-Wei Cai, Taipei City (TW); Hong-Tien Wang, Taipei City (TW); Chih-Chien Liu, Taipei City (TW); Chien Chiu, Taipei City (TW); I-Hsuan Tsai, Taipei City (TW)

(73) Assignee: COMPAL ELECTRONICS, INC., Taipei City (TW)

(21) Appl. No.: 19/399,654

(22) Filed: Nov. 25, 2025

Related U.S. Application Data
(60) Provisional application No. 63/724,881, filed on Nov. 25, 2024.

(51) Int. Cl. A63F 13/25; G06F 3/01; G06F 3/02

(52) U.S. Cl. CPC A63F 13/25; G06F 3/012; G06F 3/0202

(57) ABSTRACT

A handheld electronic device includes a device body, a display screen, a dynamic sensing unit, and a control unit. The display screen is rotatably disposed on the device body along a first rotation axis and has a display surface. The dynamic sensing unit is disposed on the device body and adapted to sense an inclination angle of the display surface relative to a horizontal plane, and the horizontal plane is perpendicular to a direction of gravity. The control unit is coupled to the dynamic sensing unit and the device body. When the inclination angle is less than a predetermined angle, the control unit controls the device body to prohibit the display screen from rotating along the first rotation axis relative to the device body. Otherwise, the control unit controls the device body to allow the display screen to rotate along the first rotation axis relative to the device body.

### CROSS-REFERENCE TO RELATED APPLICATION

This application claims the priority benefit of U.S. application Ser. No. 63/724,881, filed on Nov. 25, 2024. The entirety of the above-mentioned patent application is hereby incorporated by reference herein and made a part of this specification.

### BACKGROUND OF THE INVENTION

### Field of the Invention

The invention relates to an electronic device, and more particularly to a handheld electronic device.

### Description of Related Art

Handheld game consoles have secured a place in the consumer market due to the portability and lightweight features thereof. Some handheld game consoles offer internet browsing capabilities in addition to playing video games. Most video games are played in landscape mode, so the positions of the buttons and joysticks on handheld game consoles are generally configured to correspond to the landscape display mode of the display screen. When users use handheld game consoles instead of computers to browse vertically formatted interfaces such as web pages and social media platforms, they need to rotate the entire handheld game console to make the screen thereof vertical. This causes the positions of the buttons and joysticks on the handheld game console to change as the console is rotated, resulting in the issue of inconvenient handheld operation.

### SUMMARY OF THE INVENTION

The invention provides a handheld electronic device for which the display screen may rotate relative to the device body according to the usage context of the handheld electronic device.

A handheld electronic device of the invention includes a device body, a display screen, a dynamic sensing unit, and a control unit. The display screen is rotatably disposed on the device body along a first rotation axis and has a display surface. The dynamic sensing unit is disposed on the device body and adapted to sense an inclination angle of the display surface relative to a horizontal plane, and the horizontal plane is perpendicular to a direction of gravity. The control unit is coupled to the dynamic sensing unit and the device body. When the inclination angle is less than a predetermined angle, the control unit controls the device body to prohibit the display screen from rotating along the first rotation axis relative to the device body. When the inclination angle is not less than the predetermined angle, the control unit controls the device body to allow the display screen to rotate along the first rotation axis relative to the device body.

In an embodiment of the invention, the first rotation axis is perpendicular to the display surface.

In an embodiment of the invention, the dynamic sensing unit is adapted to sense the inclination angle caused by a rotation of the display surface along a second rotation axis, and the second rotation axis is perpendicular to the first rotation axis.

In an embodiment of the invention, the display surface has two opposite long sides and two opposite short sides, and the second rotation axis is parallel to the two long sides.

In an embodiment of the invention, the predetermined angle is between 15 degrees and 20 degrees.

In an embodiment of the invention, the control unit is adapted to control the display screen to rotate 90 degrees along the first rotation axis from a standard mode to an upright mode.

In an embodiment of the invention, the device body has at least one button, and the at least one button is adapted to be pressed to trigger the standard mode or the upright mode.

In an embodiment of the invention, the control unit is adapted to switch the display screen to a driving game mode. When the dynamic sensing unit senses a rotation amount of the device body along the first rotation axis relative to the horizontal plane, the control unit executes a driving simulation control. The driving simulation control controls the display screen to rotate along the first rotation axis relative to the device body according to the rotation amount, so that the display screen does not rotate along the first rotation axis relative to the horizontal plane.

In an embodiment of the invention, the device body has at least one button, and the at least one button is adapted to be pressed to trigger a driving game mode.

In an embodiment of the invention, the display surface has two opposite long sides and two opposite short sides. When the display screen is in the driving game mode, the control unit controls the display screen to keep the two long sides parallel to the horizontal plane.

In an embodiment of the invention, the handheld electronic device further includes an image capture unit, wherein the image capture unit is disposed on the display device and coupled to the control unit. The image capture unit is adapted to capture a facial image of a user to obtain a facial reference axis. The display surface has two opposite long sides and two opposite short sides. When the display screen is in the driving game mode, the control unit controls the display screen to keep the two long sides parallel to the facial reference axis.

In an embodiment of the invention, the facial reference axis is a connecting line of two eyes in the facial image or a connecting line of two eyebrows in the facial image.

In an embodiment of the invention, the control unit performs driving simulation control when the rotation amount is greater than a threshold for a predetermined time length.

In an embodiment of the invention, the predetermined time length is between 10 milliseconds and 20 milliseconds.

In an embodiment of the invention, the device body includes a body and a drive unit. The drive unit is disposed on the body and connected to the display screen. The drive unit is coupled to the control unit and adapted to drive the display screen to rotate along the first rotation axis.

In an embodiment of the invention, the device body has two handles, and a receiving groove is formed between the two handles. The receiving groove has two opposite arc-shaped inner edges. The display screen is located in the receiving groove and has two opposite arc-shaped outer edges. The two arc-shaped outer edges correspond to the two arc-shaped inner edges respectively. When the display screen rotates along the first rotation axis relative to the device body, each of the arc-shaped outer edges slides along the arc-shaped inner edge.

In an embodiment of the invention, each of the arc-shaped inner edges is concave, and each of the arc-shaped outer edges is convex.

In an embodiment of the invention, a radius of curvature of each of the arc-shaped inner edges is equal to a radius of curvature of the corresponding arc-shaped outer edge.

In an embodiment of the invention, a curvature center of each of the arc-shaped inner edges and a curvature center of each of the arc-shaped outer edge coincide on the first rotation axis.

In an embodiment of the invention, the handheld electronic device further includes at least one light-emitting unit, wherein the at least one light-emitting unit is disposed on the device body and extends along at least one of the arc-shaped inner edges.

Based on the above, in the handheld electronic device of the invention, the display screen may be rotated to a vertical position relative to the device body to adapt to the usage context of vertical screens such as browsing web pages and social media platforms. At this time, the device body itself does not rotate, so as not to cause inconvenience in hand operation due to the rotation of the entire handheld electronic device. Furthermore, in driving games, such as racing or flying challenges, when the user rotates the device body along a rotation axis perpendicular to the display surface to simulate steering wheel control, the display screen may remain stationary relative to the user by rotating relative to the rotation axis between the display screen and the device body along the rotation axis, thus simulating the game experience of controlling a steering wheel in the real world. Furthermore, in a driving game context, the control unit of the handheld electronic device may allow the display screen to rotate relative to the device body along the rotation axis only when the device body has a sufficiently large inclination angle relative to the horizontal plane. Therefore, when the inclination angle of the device body relative to the horizontal plane is not large enough to accurately sense the rotation angle of the device body along the rotation axis, the incorrect rotation of the display screen due to misjudgment of the rotation angle of the device body may be avoided.

### BRIEF DESCRIPTION OF THE DRAWINGS

FIG. 1A to FIG. 1C respectively illustrate different usage contexts of a handheld electronic device of an embodiment of the invention.

FIG. 2 is a schematic diagram of the handheld electronic device of FIG. 1A.

FIG. 3A to FIG. 3C illustrate the operation method of the handheld electronic device of FIG. 2 in driving game mode.

FIG. 4A to FIG. 4C are side views of the handheld electronic devices of FIG. 3A to FIG. 3C, respectively.

FIG. 5A to FIG. 5B illustrate a facial image of a user captured by the image capture unit of FIG. 2.

FIG. 6A illustrates the handheld electronic device of FIG. 2 controlling the display screen in driving game mode based on the facial image of the user of FIG. 5A.

FIG. 6B illustrates the handheld electronic device of FIG. 2 controlling the display screen in driving game mode based on the facial image of the user of FIG. 5B.

FIG. 7 is a flowchart of the handheld electronic device of FIG. 2 controlling the rotation of the display screen.

FIG. 8 is a detailed flowchart of some steps related to FIG. 7.

FIG. 9 is a detailed flowchart of the correction angle data related to FIG. 7.

FIG. 10 is a partial perspective view of the handheld electronic device of FIG. 1B.

FIG. 11A to FIG. 11C illustrate the operation method of a handheld electronic device of another embodiment of the invention.

FIG. 12A to FIG. 12B illustrate the operation method of a handheld electronic device of another embodiment of the invention.

FIG. 13A to FIG. 13B illustrate the operation method of a handheld electronic device of another embodiment of the invention.

FIG. 14A to FIG. 14B illustrate the operation method of a handheld electronic device of another embodiment of the invention.

FIG. 15A to FIG. 15B illustrate the operation method of a handheld electronic device of another embodiment of the invention.

### DESCRIPTION OF THE EMBODIMENTS

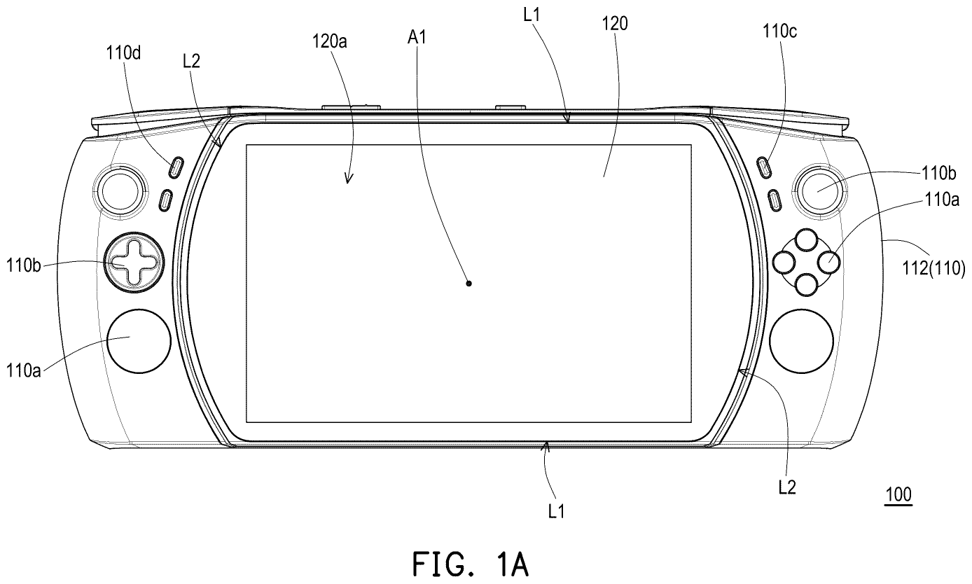

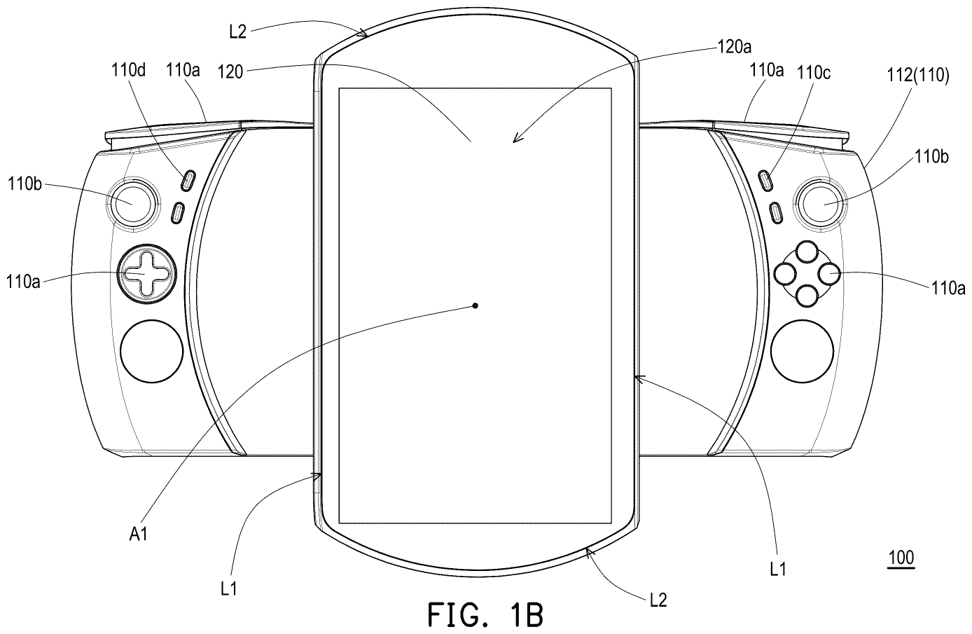

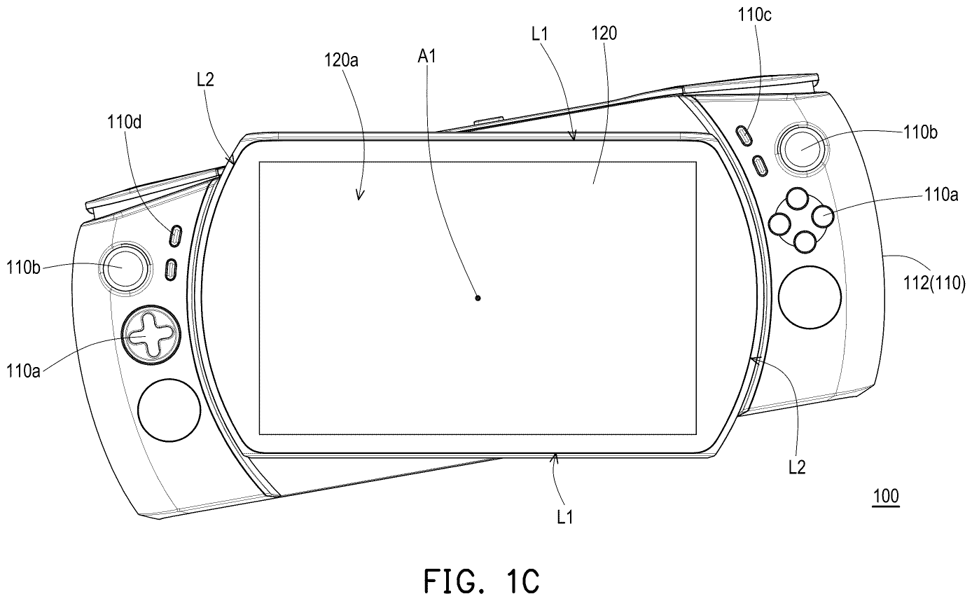

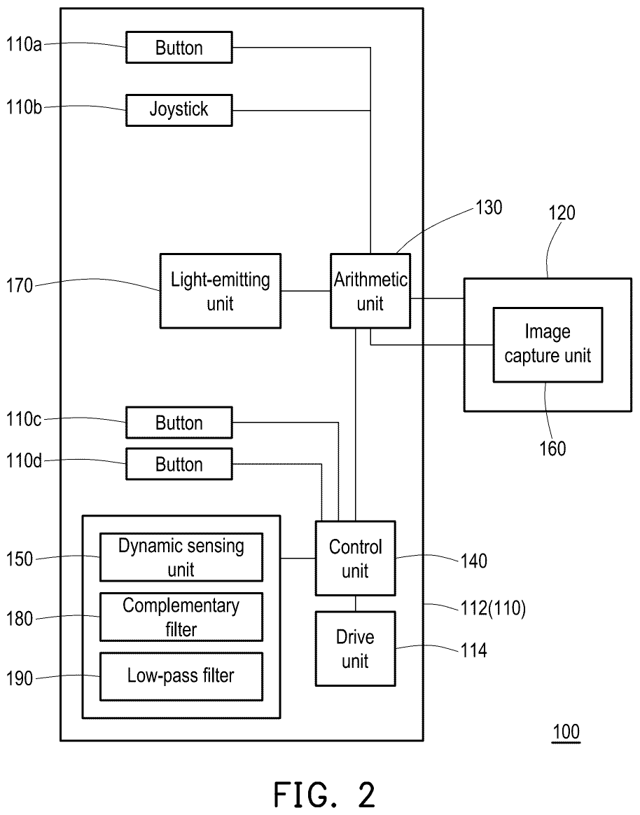

FIG. 1A to FIG. 1C respectively illustrate different usage contexts of a handheld electronic device of an embodiment of the invention. FIG. 2 is a schematic diagram of the element architecture of the handheld electronic device of FIG. 1A. Please refer to FIG. 1A to FIG. 1C and FIG. 2. A handheld electronic device 100 of the present embodiment is, for example, a handheld game console and includes a device body 110, a display screen 120, an arithmetic unit 130, and a control unit 140. The device body 110 includes a body 112 and a drive unit 114. The drive unit 114 is, for example, a motor and is disposed on the body 110. The display screen 120 has a display surface 120a, and the display surface 120a has two opposite long sides L1 and two opposite short sides L2. The display screen 120 is rotatably disposed on the body 112 of the device body 110 along a first rotation axis A1 perpendicular to the display surface 120a. The drive unit 114 is connected to the display screen 120 and coupled to the control unit 140. The drive unit 114 (e.g., a drive motor) is used to drive the display screen 120 to rotate along the first rotation axis A1.

The arithmetic unit 130 includes, for example, a central processing unit (CPU) and a graphics processing unit (GPU) and is disposed in the body 112 of the device body 110. The device body 110 has a plurality of buttons 110a and a plurality of joysticks 110b. The control signals generated by the user operating the buttons 110a and the joysticks 110b are transmitted to the arithmetic unit 130, and the arithmetic unit 130 then controls the display screen 120 to display the corresponding image.

The control unit 140 is, for example, a microcontroller (MUC) and is disposed in the body 112 of the device body 110. The device body 110 has a button 110c, and the control unit 140 is coupled to the button 110c of the device body 110. The button 110c is adapted to be pressed by the user to trigger the standard mode as shown in FIG. 1A or the upright mode as shown in FIG. 1B. Specifically, the control signal generated by the user pressing the button 110c is transmitted to the control unit 140, so that the control unit 140 controls the drive unit 140 to drive the display screen 120 to rotate 90 degrees along the first rotation axis A from the standard mode as shown in FIG. 1A to the upright mode as shown in FIG. 1B, or so that the control unit 140 controls the drive unit 140 to drive the display screen 120 to rotate 90 degrees along the first rotation axis A from the upright mode as shown in FIG. 1B to the standard mode as shown in FIG. 1A.

Accordingly, in addition to being in the standard mode as shown in FIG. 1A for users to play games, the display screen 120 may also be rotated to an upright mode relative to the device body 110 as shown in FIG. 1B to adapt to the usage context of vertical screens such as browsing web pages and social media platforms. At this time, the device body 110 itself does not rotate, so as not to cause inconvenience in hand operation due to the rotation of the entire handheld electronic device 100. That is, in the upright mode as shown in FIG. 1B, the user may still operate the buttons 110a and the joysticks 110b on the device body 110 smoothly.

In addition, the device body 110 has a button 110d, and the control unit 140 is coupled to the button 110d of the device body 110. The button 110d is adapted to be pressed by the user to trigger the driving game mode as shown in FIG. 1C. Specifically, the handheld electronic device 100 further includes a dynamic sensing unit 150, and the dynamic sensing unit 150 is coupled to the control unit 140. The dynamic sensing unit 150 is, for example, an inertial measurement unit (IMU) including an accelerometer, a gyroscope, etc., and is disposed on the body 112 of the device body 110. The control signal generated by the user pressing the button 110d is transmitted to the control unit 140, so that the control unit 140 controls the display screen 120 to switch the display screen 120 to the driving game mode. In the driving game mode, when the dynamic sensing unit 150 senses a rotation amount of the device body 110 along the first rotation axis A1 relative to a reference plane in space (such as a horizontal plane perpendicular to the direction of gravity), the control unit 140 executes a driving simulation control. The driving simulation control controls the display screen 120 to rotate along the first rotation axis A1 relative to the device body 110 according to the rotation amount of the device body 110, so that the display screen 120 does not rotate along the first rotation axis A1 relative to the reference plane in space (such as a horizontal plane perpendicular to the direction of gravity).

In other words, in a driving game context, when the user rotates the device body 110 along the first rotation axis A1 perpendicular to the display surface 120a to simulate steering wheel control, the display screen 120 and the device body 110 may be misaligned by rotating relative to each other along the first rotation axis A1, so that the display screen 120 still does not rotate relative to the user as shown in FIG. 1C, thus simulating the game experience of controlling a steering wheel like in real-world driving.

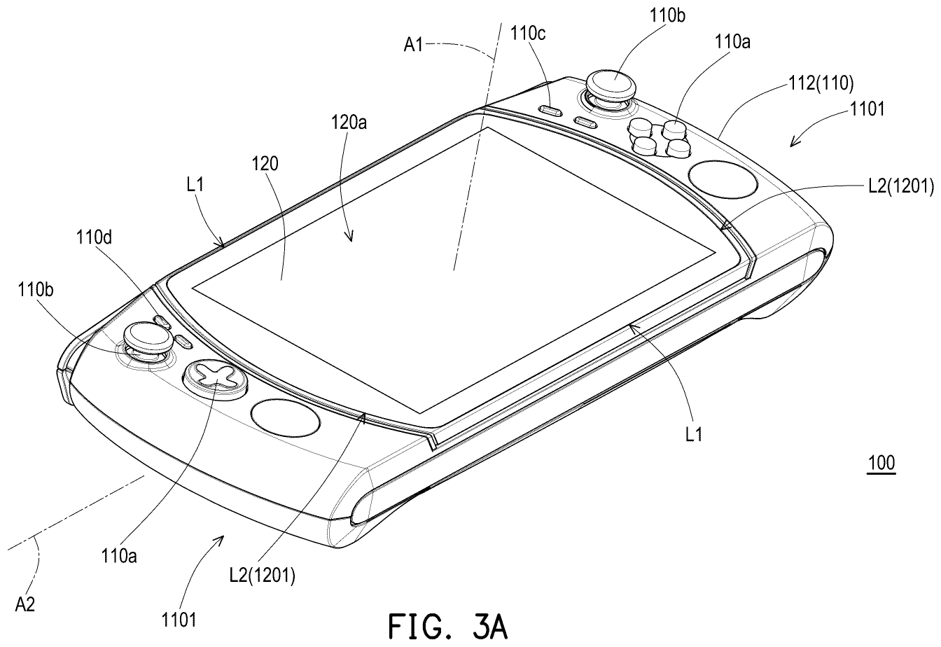

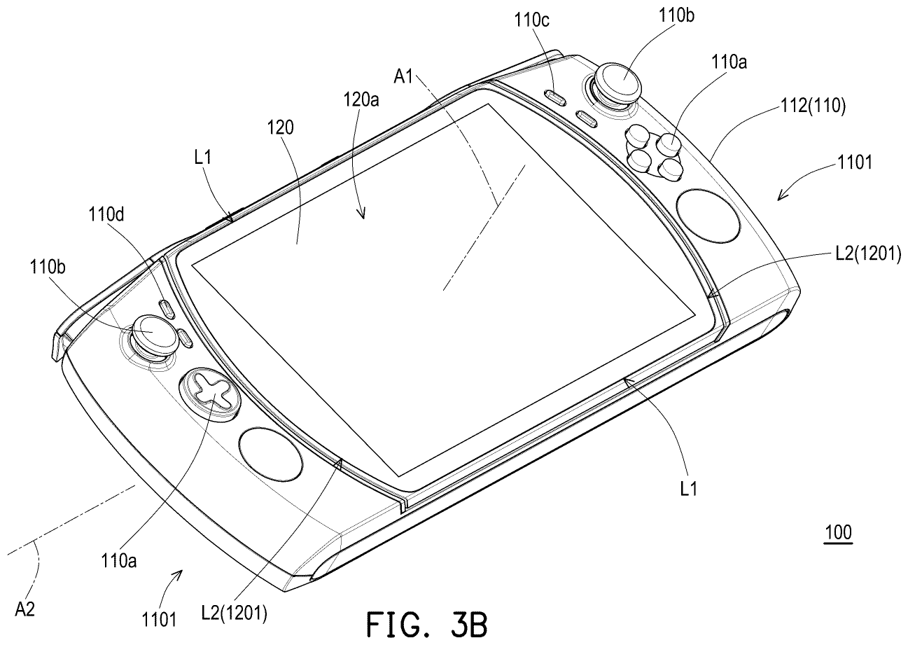

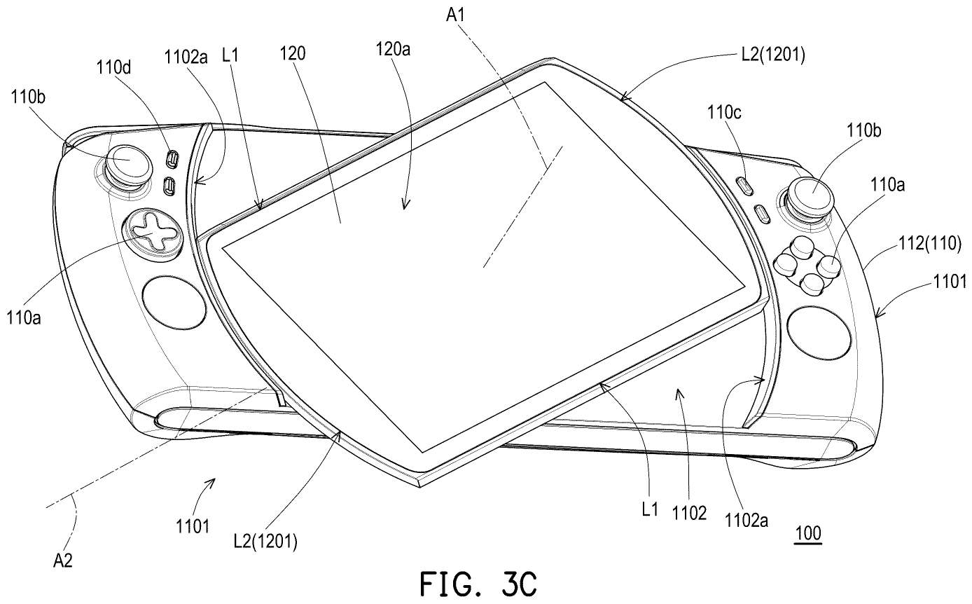

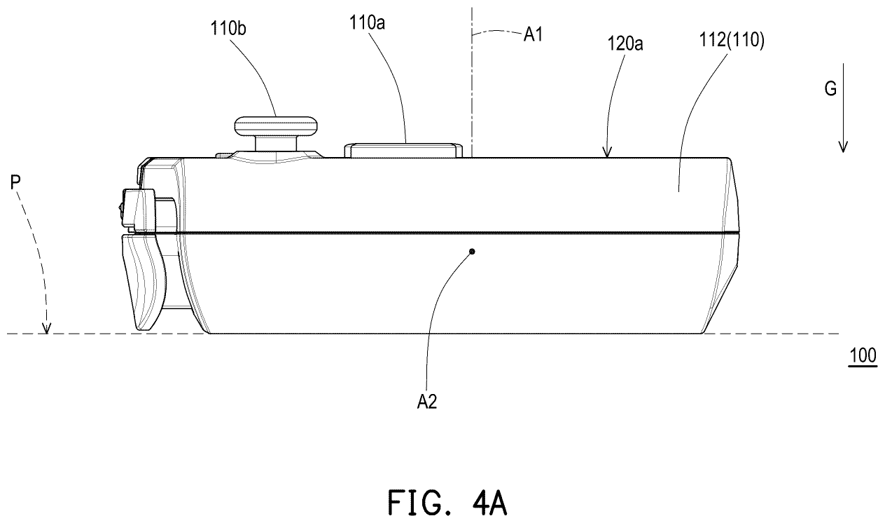

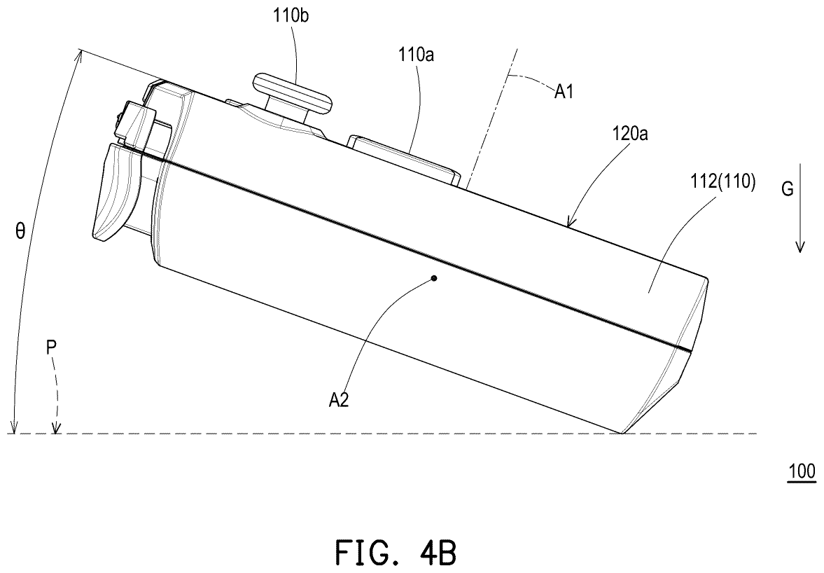

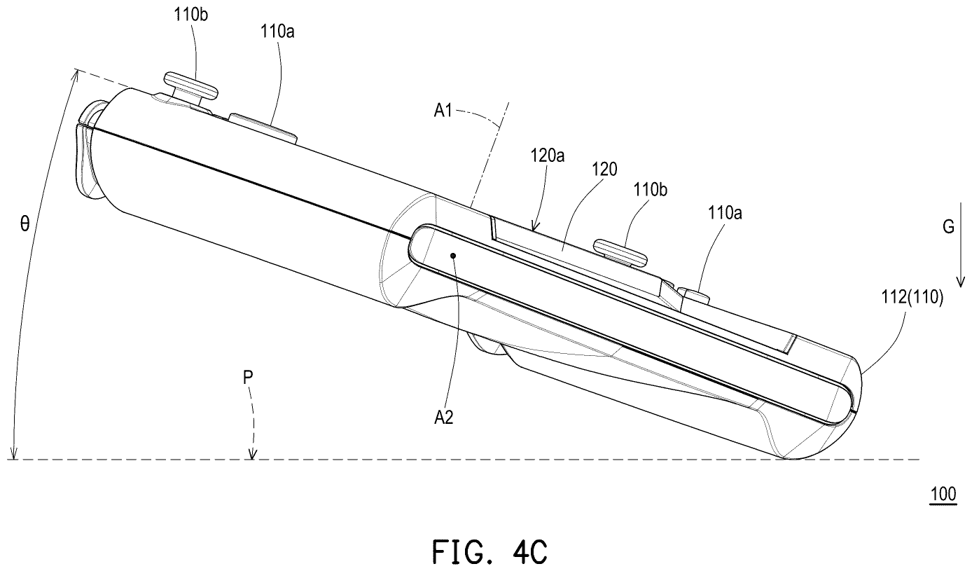

FIG. 3A to FIG. 3C illustrate the operation method of the handheld electronic device of FIG. 2 in driving game mode. FIG. 4A to FIG. 4C are side views of the handheld electronic devices of FIG. 3A to FIG. 3C, respectively. In the present embodiment, the dynamic sensing unit 150 is adapted to sense the inclination angle of the display surface 120a relative to the horizontal plane P (i.e., the horizontal plane perpendicular to the direction of gravity G) caused by the rotation of the display surface 120a along a second rotation axis A2 perpendicular to the first rotation axis A. The second rotation axis A2 is, for example, parallel to the two opposite long sides L1 of the display surface 120a and perpendicular to the two opposite short sides L2 of the display surface 120a. When the handheld electronic device 100 is in the state as shown in FIG. 4A and FIG. 4B such that the inclination angle is less than a predetermined angle θ (e.g., between 15 degrees and 20 degrees), the control unit 140 controls the device body 110 to prohibit the display screen 120 from rotating along the first rotation axis A1 relative to the device body 110, as shown in FIG. 3B. When the inclination angle is not less than the predetermined angle θ as shown in FIG. 4C (illustrated as the inclination angle being equal to the predetermined angle θ), the control unit 140 controls the device body 110 to allow the display screen 120 to rotate relative to the device body 110 along the first rotation axis A1 as shown in FIG. 4C and FIG. 3C. In the present embodiment, the control unit 140 drives the display screen 120 to rotate along the first rotation axis A1 by controlling the drive unit 114 (e.g., a drive motor).

In other words, in the driving game context, the control unit 140 of the handheld electronic device 100 only allows the display screen 120 to rotate along the first rotation axis A1 relative to the device body 110 to perform driving simulation control when the device body 110 has a sufficiently large inclination angle relative to the horizontal plane P. This is because when the inclination angle of the device body 110 relative to the horizontal plane P is not large enough, the dynamic sensing unit 150 is prone to misjudgment and it is difficult to accurately sense the rotation angle of the device body 110 along the first rotation axis A1. Therefore, by using the above inclination angle limitation, the display screen 120 may be prevented from rotating incorrectly due to misjudgment of the rotation angle of the device body 110.

In the present embodiment, when the display screen 120 is in the driving game mode, the control unit 140 controls the display screen 120 to keep the two long sides L1 of the display screen 120 parallel to the horizontal plane P. It is worth noting that both the conventional inertial sensing unit and the dynamic sensing unit 150 of the above embodiment use the horizontal plane perpendicular to the direction of gravity G as the line-of-sight reference angle of the display screen 120 (i.e., keeping the display screen 120 horizontal and stable). However, this only applies to the user viewing the display screen 120 in a standing or sitting position. Therefore, considering that users may use the handheld electronic device 100 in a crooked posture such as lying down, resulting in a viewing angle that is not parallel to the horizontal plane, the control unit 140 of the present embodiment may further obtain a suitable line-of-sight reference angle again according to the degree of face tilt of the user in the driving game mode to control the rotation angle of the display screen 120, as detailed below.

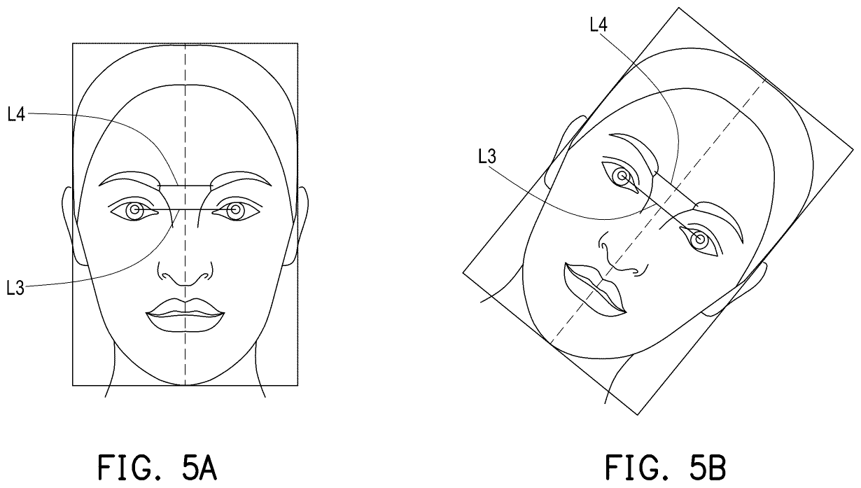

FIG. 5A to FIG. 5B illustrate the facial image of the user captured by the image capture unit of FIG. 2. In the present embodiment, the handheld electronic device 100, as shown in FIG. 2, further includes an image capture unit 160, and the image capture unit 160 is, for example, a camera lens and is disposed on the display device 120 and coupled to the control unit 140. The image capture unit 160 is adapted to capture the facial image of the user and analyze the facial image through the calculation model of the arithmetic unit 130 to obtain facial reference axes L3 and L4 (as shown in FIG. 5A to FIG. 5B). The facial reference axis L3 is the connecting line of two eyes in the facial image, and the facial reference axis L4 is the connecting line of two eyebrows in the facial image. When the display screen 120 is in the driving game mode, the control unit 140 controls the display screen 120 so that the two long sides L1 of the display surface 120a are kept parallel to the facial reference axis L3 or the facial reference axis L4. In one example, the computational model may use a pre-trained deep learning model, such as a convolutional neural network (CNN), to annotate facial key points and then calculate the facial reference axes L3 and L4.

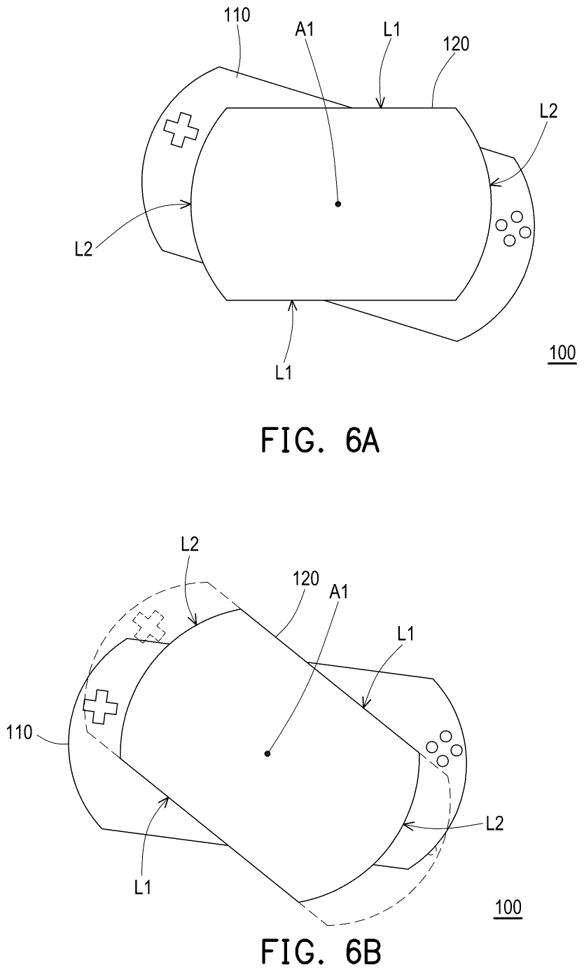

FIG. 6A illustrates the handheld electronic device of FIG. 2 controlling the display screen in driving game mode based on the facial image of the user of FIG. 5A. FIG. 6B illustrates the handheld electronic device of FIG. 2 controlling the display screen in driving game mode based on the facial image of the user of FIG. 5B. Specifically, when the facial reference axis L3 and/or the facial reference axis L4 are horizontal lines as shown in FIG. 5A, the control unit 140 controls the display screen 120 to keep the two long sides L1 of the display surface 120a in a horizontal state as shown in FIG. 6A. When the facial reference axis L3 and/or the facial reference axis L4 are slanted lines as shown in FIG. 5B, the control unit 140 updates the line-of-sight reference angle of the display screen 120 based on the angle data of the two eyes, thereby controlling the display screen 120 to maintain the two long sides L1 of the display surface 120a in the corresponding inclined state as shown in FIG. 6B.

Accordingly, when a user uses the handheld electronic device 100 in a crooked posture such as lying down, the display screen 120 may rotate relative to the device body 110 to a corresponding tilted state according to the degree of face tilt of the user, so that the eyes of the user and the display screen 120 are kept in a state of not tilted relative to each other, thereby improving the viewing and operating experience of the user.

Furthermore, in the present embodiment, the control unit 140 executes the driving simulation control only when the rotation amount of the device body 110 along the first rotation axis A1 is greater than a threshold for a predetermined time length (e.g., between 10 milliseconds and 20 milliseconds). Therefore, the control unit 140 misinterpreting slight vibrations of the handheld electronic device 100 or slight vibrations of the dynamic sensing unit 150 and the drive unit 114 updating the angle as the user intending to activate the driving simulation control may be avoided.

Please refer to FIG. 3A to FIG. 3C. In the present embodiment, the device body 110 has two handles 1101, and a receiving groove 1102 is formed between the two handles 1101 (as shown in FIG. 3C). The receiving groove 1102 has two opposite arc-shaped inner edges 1102a, the display screen 120 is located in the receiving groove 1102 and has two opposite arc-shaped outer edges 1201, and the two opposite arc-shaped outer edges 1201 correspond to the two arc-shaped inner edges 1102a respectively. Each of the arc-shaped inner edges 1102a is concave, and each of the arc-shaped outer edges 1201 is convex. The radius of curvature of each of the arc-shaped inner edges 1102a is equal to the radius of curvature of the corresponding arc-shaped outer edge 1201. The curvature center of each of the arc-shaped inner edges 1102a and the curvature center of each of the arc-shaped outer edges 1201 coincide on the first rotation axis A1. When the display screen 120 rotates relative to the device body 110 along the first rotation axis A1, each of the arc-shaped outer edges 1201 slides along the arc-shaped inner edge 1102a. Accordingly, the display screen 120 may rotate freely along the first rotation axis A1 without being obstructed by the device body 110.

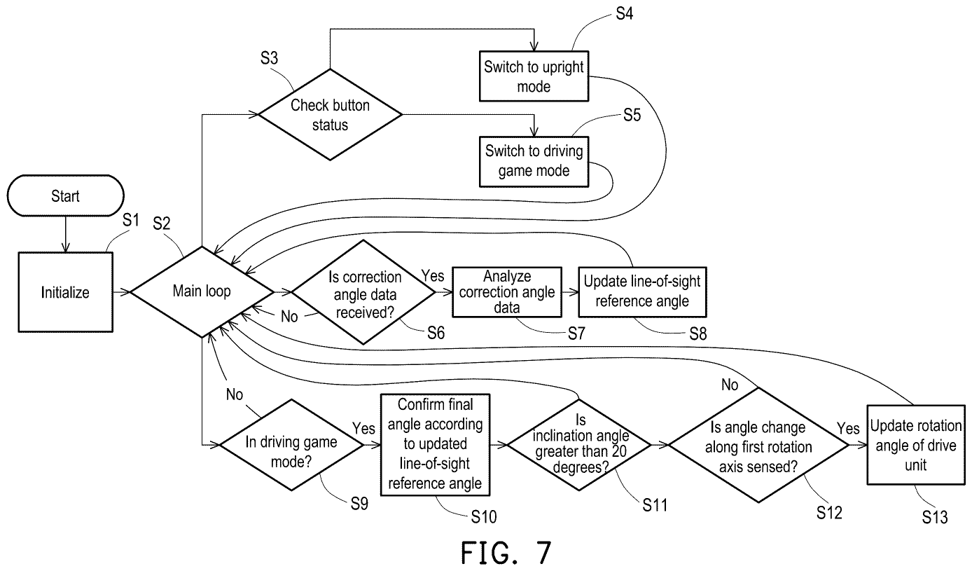

The following describes the specific process by which the handheld electronic device 100 controls the rotation of the display screen 120 of the present embodiment. FIG. 7 is a flowchart of the handheld electronic device of FIG. 2 controlling the rotation of the display screen. Please refer to FIG. 7. First, step S1 is the initialization, including, for example, enabling the function setting of the arithmetic unit 130, calibrating the gravity vector and coordinate system of the dynamic sensing unit 150, and adjusting the drive motor, and then entering the main loop (step S2). At this point, the system, in the main loop, includes checking the button status (step S3), detecting whether correction angle data is received (step S6), and detecting whether the system is in driving game mode (step S9). Specifically, after step S3, regardless of whether the button 110c is switched to upright mode (step S4) or driving game mode (step S5), the system returns to the main loop (step S2).

Moreover, in step S6, whether the correction angle data is received is detected. If “no”, step S2 is repeated. If “yes”, the correction angle data is analyzed according to the embodiments as shown in FIG. 5A to FIG. 6B (step S7) and the line-of-sight reference angle is updated accordingly (step S8).

Moreover, in step S9, whether the system is in driving game mode is determined. If “no”, step S2 is repeated. If “yes”, the final angle is confirmed according to the updated line-of-sight reference angle (step S10).

It should be noted that after the user presses the button 110c to switch to driving game mode (step S5), the main loop of step S2 adds detection step S9. Step S9 mainly determines whether the game being played by the user supports driving game mode, or whether the user launched to enter the display screen of the driving game.

Furthermore, in step S10, the final angle is confirmed to be calculated based on the updated line-of-sight reference angle obtained in step S8. Therefore, if the system has not executed step S6 to step S8 from the beginning, step S10 may be skipped and subsequent step S11 to step S13 may be executed directly.

Next, in step S11, whether the inclination angle of the device body 110 is greater than 20 degrees (corresponding to the predetermined angle θ as shown in FIG. 4B and FIG. 4C) is determined. If “no”, step S2 is repeated. If “yes”, step S12 is performed to determine whether the angle change of the device body 110 along the first rotation axis A1 is sensed. If “no”, step S2 is repeated. If “yes”, step S13 is performed to update the angle of the drive unit 114.

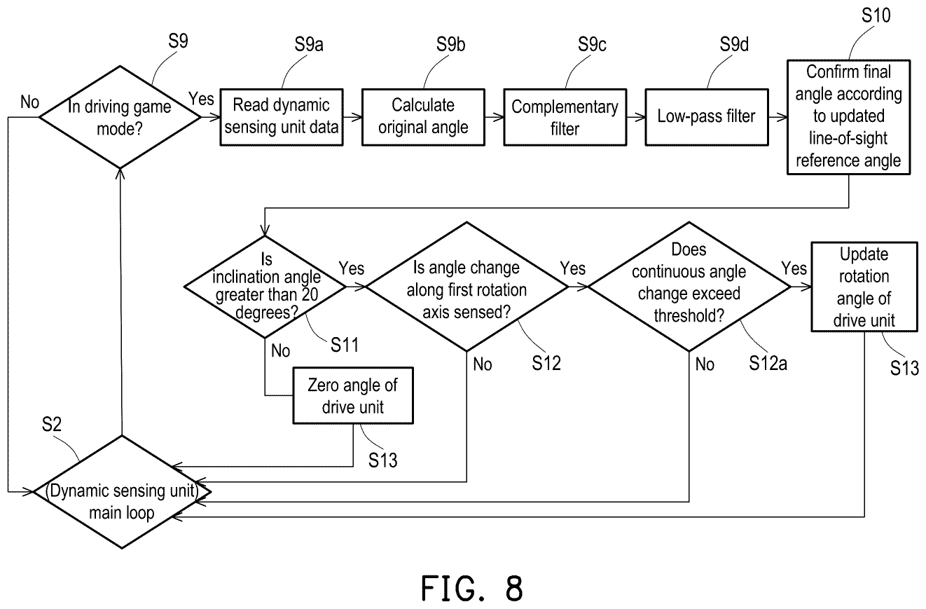

FIG. 8 is a detailed flowchart of some steps related to FIG. 7, and related to the operation method of the driving simulation control as shown in FIG. 3A to FIG. 4C. Please refer to FIG. 8. In the present embodiment, the main loop of step S2 is to continuously check the signal input, process, and output of, for example, an accelerometer and a gyroscope by the dynamic sensing unit 150. After determining whether the system is in driving game mode in step S9, if “yes”, the data of the dynamic sensing unit 150 is read (step S9a), the original angle of the device body 110 is calculated (step S9b), a more accurate angle is obtained through a complementary filter 180 as shown in FIG. 2 (step S9c), and the output angle is further smoothed through a low-pass filter 190 as shown in FIG. 2 (step S9d). Then, the above steps S10, S11, and S12 are executed in sequence. After step S12, whether the continuous angle change range of the device body 110 along the first rotation axis A1 is greater than the aforementioned threshold (step S12a) is determined. If “no”, step S2 is repeated. If “yes”, step S13 is performed to update the rotation angle of the drive unit 114, so that the display screen 120 remains horizontal and stable as shown in FIG. 1C and does not rotate relative to the user.

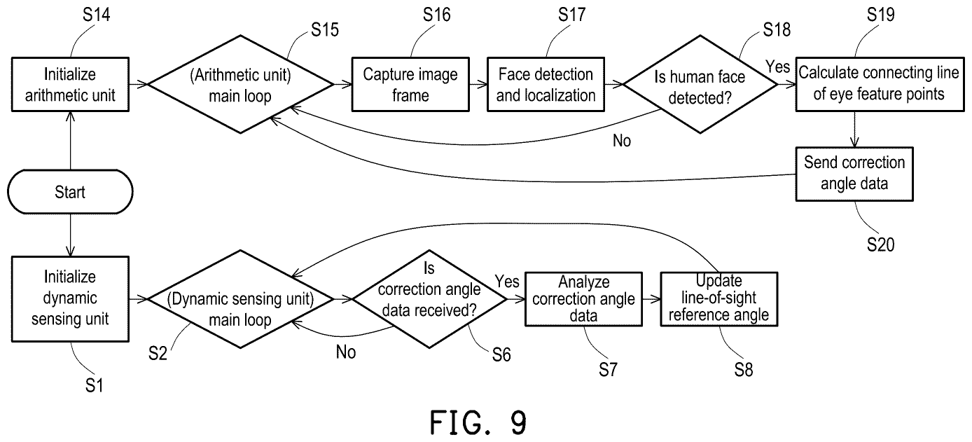

FIG. 9 is a detailed flowchart of the correction angle data related to FIG. 7. Please refer to FIG. 9. In addition to performing the above step S1 to step S8 (corresponding to the calculation and updating of the line-of-sight reference angle as shown in FIG. 6A to FIG. 6B), the following step S15 to step S20 (corresponding to the analysis of the angle data of the two eyes as shown in FIG. 5A to FIG. 5B) are also performed. The arithmetic unit 130 is initialized (step S14) and the main loop of the arithmetic unit 130 is entered (step S15). It is worth noting that in the present embodiment, the initialization of the arithmetic unit 130 in step S14 may be functions such as starting the camera module, loading the above facial image calculation model, and connecting a Universal Asynchronous Receiver/Transmitter (UART). The main loop of step S15 is responsible for continuously checking the signal input, processing, and output of the above functions by the arithmetic unit. Image frames are captured from the image capture unit 160 (step S16) and face detection and localization are performed (step S17). Whether a face is detected is determined (step S18). If “no”, step S15 is returned. If “yes”, in step S19, the connecting line of eye feature points (i.e., the above facial reference axis L3 and/or facial reference axis L4) is analyzed and calculated by the calculation model. Next, the correction angle data (step S20) is sent to the arithmetic unit 130, so that the dynamic sensing unit 150 may perform the above step S6 to determine whether the correction angle data is received.

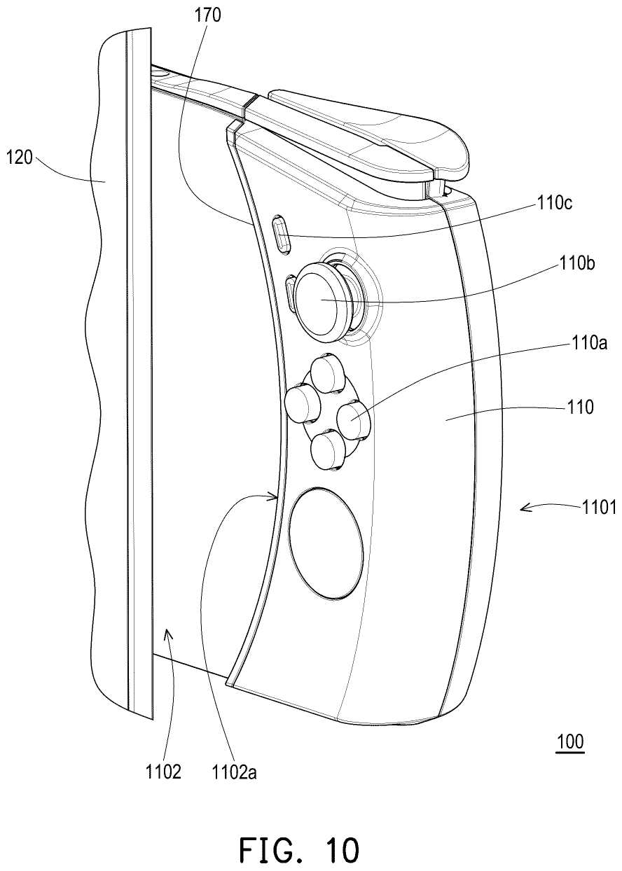

FIG. 10 is a partial perspective view of the handheld electronic device of FIG. 1B. Please refer to FIG. 2 and FIG. 10. In the present embodiment, the handheld electronic device 100 further includes a light-emitting unit 170, and the light-emitting unit 170 is disposed on the device body 110 and extends along the arc-shaped inner edges 1102a of the receiving groove 1102. The light-emitting unit 170 may include a light-emitting diode light source and may be used as an ambient light. For example, when the handheld electronic device 100 is turned on, the light-emitting unit 170 may emit colored light corresponding to the power-on screen. When the handheld electronic device 100 is turned off, the light-emitting unit 170 may emit colored light corresponding to the power-off screen. When the handheld electronic device 100 is in standby mode, the light-emitting unit 170 may emit white light with alternating brightness and darkness. When the handheld electronic device 100 is charging, the light-emitting unit 170 may emit orange light with alternating brightness and darkness. When the handheld electronic device 100 is low on power, the light-emitting unit 170 may continuously emit orange light. When the handheld electronic device 100 is charging, the light-emitting unit 170 may emit orange light with alternating brightness and darkness. When the handheld electronic device 100 displays an error message, the light-emitting unit 170 may continuously emit red light. When the handheld electronic device 100 is in normal gaming mode, the light-emitting unit 170 may emit colored light corresponding to the game screen. When the handheld electronic device 100 is in the driving game mode, the light-emitting unit 170 may emit a darker upper and lighter lower or lighter upper and darker lower gradient blue light based on a right turn or a left turn, emit blue light based on straight-line movement, emit orange light based on braking, and emit red light based on a crash. When the handheld electronic device 100 is in the upright mode, the light-emitting unit 170 may emit colored light corresponding to the displayed screen.

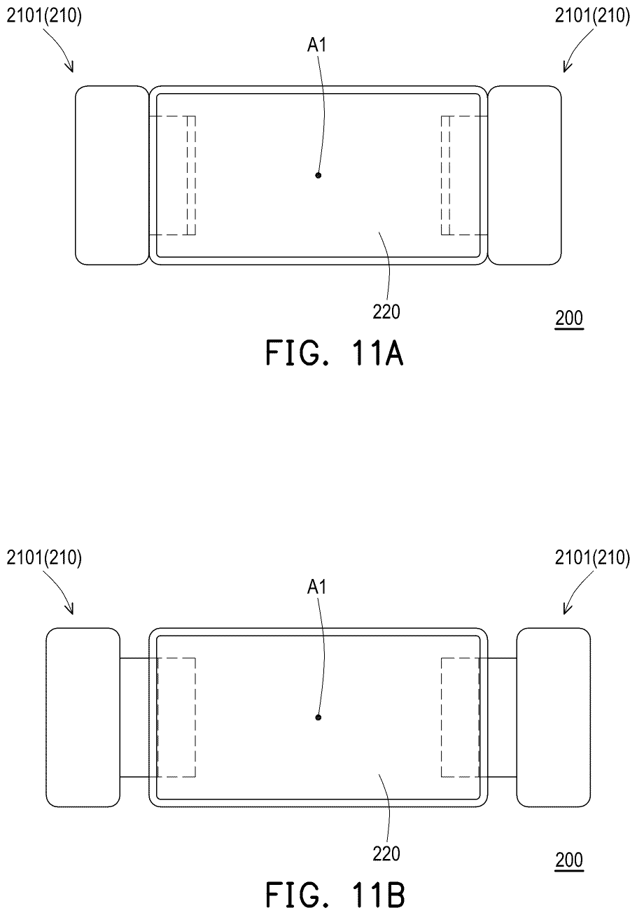

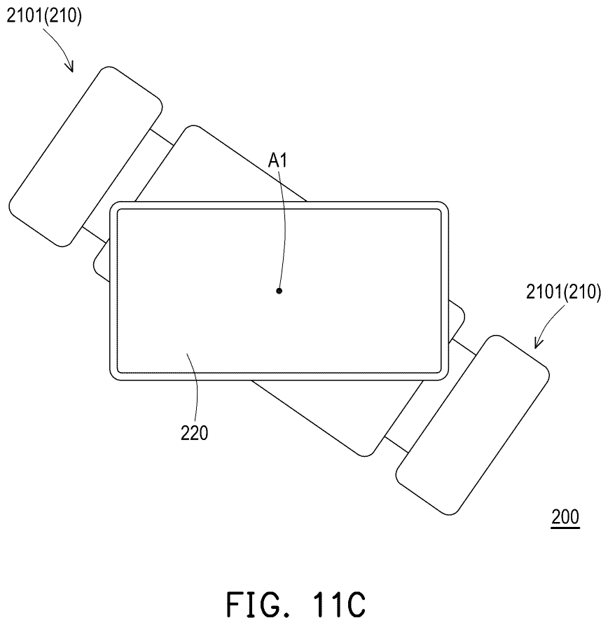

FIG. 11A to FIG. 11C illustrate the operation method of a handheld electronic device of another embodiment of the invention. Please refer to FIG. 11A to FIG. 11C. The main difference between a handheld electronic device 200 of the present embodiment and the above embodiment is that a handle 2101 of the present embodiment is slidably disposed on the device body 210 and does not have the arc-shaped inner edge design of the above embodiment, and a display screen 220 does not have the arc-shaped outer edge design of the above embodiment. When the handle 2101 is against the display screen 220 as shown in FIG. 11A, the display screen 220 is restricted by the handle 2101 from rotating along the first rotation axis A1. When the handle 2101 slides outward as shown in FIG. 11B to release the display screen 220, the display screen 220 may rotate along the first rotation axis A1 as shown in FIG. 11C.

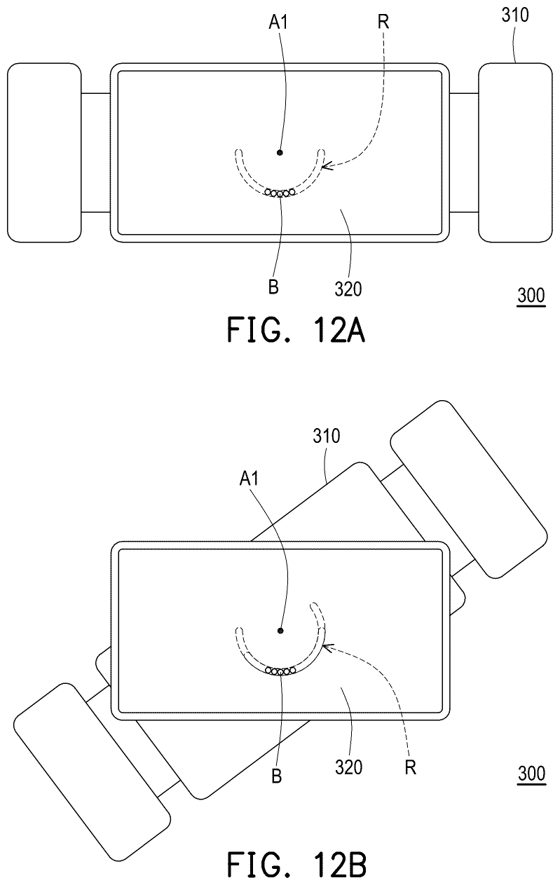

FIG. 12A to FIG. 12B illustrate the operation method of a handheld electronic device of another embodiment of the invention. Please refer to FIG. 12A to FIG. 12B. The main difference between a handheld electronic device 300 of the present embodiment and the above embodiment is that a device body 310 and a display screen 320 of the present embodiment together form an arc-shaped slide rail R therebetween, and a plurality of ball bearings B are disposed in the arc-shaped slide rail R. When the display screen 220 rotates along the first rotation axis A1 as shown in FIG. 12B, the rotation range may be limited by the arc-shaped slide rail R and the friction may be reduced by the ball bearings B.

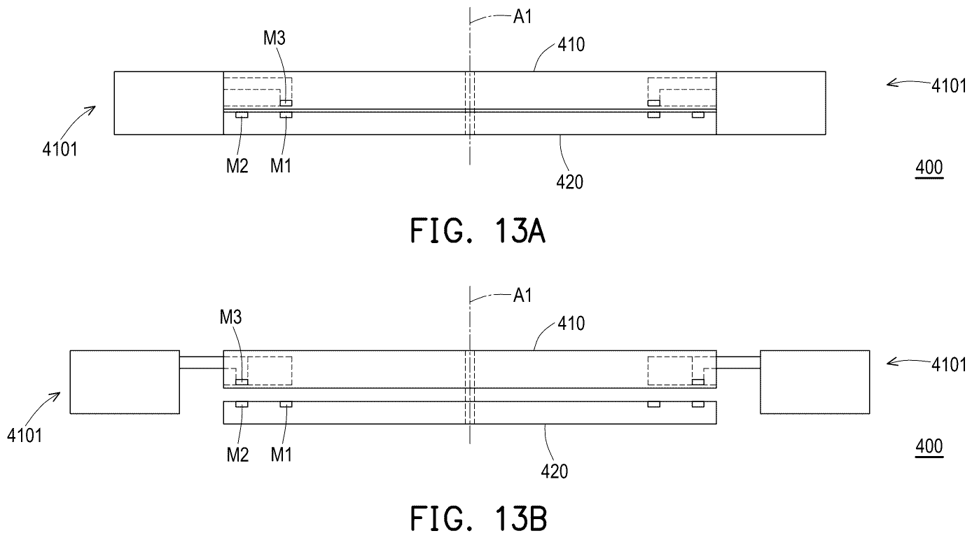

FIG. 13A to FIG. 13B illustrate the operation method of a handheld electronic device of another embodiment of the invention. Please refer to FIG. 13A to FIG. 13B. The main difference between a handheld electronic device 400 of the present embodiment and the above embodiment is that a display screen 420 of the present embodiment has a magnet group M1 and a magnet group M2, and a device body 410 has a magnet group M3. When a handle 4101 is abutted against the display screen 420 as shown in FIG. 13A, the magnet group M1 and the magnet group M3 attract each other, so that the device body 410 and the display screen 42 move closer to each other. When the handle 4101 slides outward as shown in FIG. 13B, the magnet group M1 and the magnet group M2 repel each other, so that the device body 410 and the display screen 420 move away from each other and form a gap, reducing the friction between the device body 410 and the display screen 420 when rotating relative to each other along the first rotation axis A1.

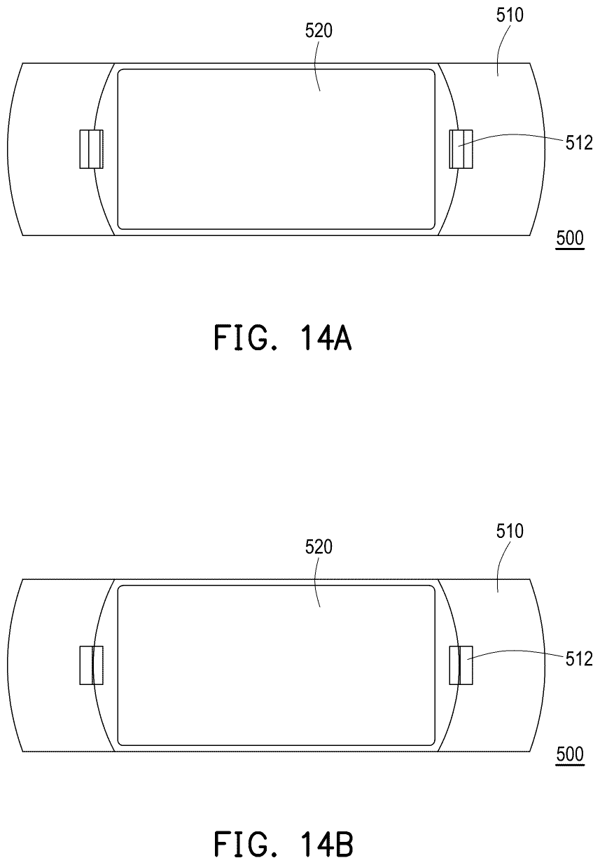

FIG. 14A to FIG. 14B illustrate the operation method of a handheld electronic device of another embodiment of the invention. Please refer to FIG. 14A to FIG. 14B. The main difference between a handheld electronic device 500 of the present embodiment and the above embodiment is that a device body 510 of the present embodiment is provided with a locking member 512. When the locking member 512 locks the display screen 520 as shown in FIG. 14A, the display screen 520 may not rotate along the first rotation axis A1 relative to the device body 510. When the locking member 512 releases the display screen 520 as shown in FIG. 14B, the display screen 520 may rotate relative to the device body 510 along the first rotation axis A1.

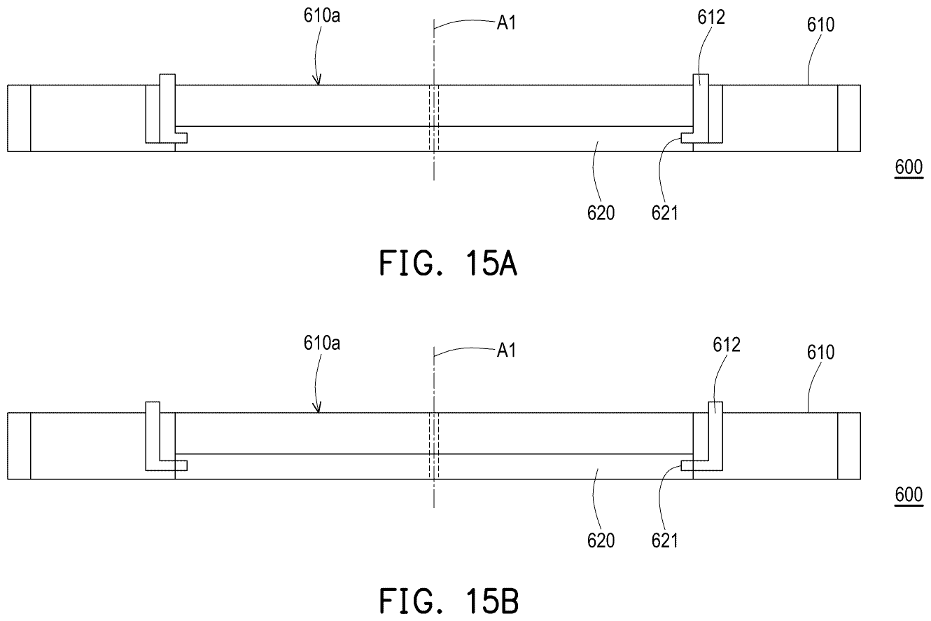

FIG. 15A to FIG. 15B illustrate the operation method of a handheld electronic device of another embodiment of the invention. Please refer to FIG. 15A to FIG. 15B. The main difference between a handheld electronic device 500 of the present embodiment and the embodiment of FIG. 14A to FIG. 14B is that a locking member 612 of the present embodiment is exposed on a back side 610a of a device body 610 so that the user may operate the locking member 612 on the back side 610a of the device body 610. When the locking member 612 engages with a recess 621 of the display screen 620 as shown in FIG. 15A to lock the display screen 620, the display screen 620 may not rotate relative to the device body 610 along the first rotation axis A1. When the locking member 612 moves away from a notch 621 of the display screen 620 as shown in FIG. 15B and releases the display screen 620, the display screen 620 may rotate relative to the device body 610 along the first rotation axis A1.

Based on the above, in the handheld electronic device of the invention, the display screen may be rotated to a vertical position relative to the device body to adapt to the usage context of vertical screens such as browsing web pages and social media platforms. At this time, the device body itself does not rotate, so as not to cause inconvenience in hand operation due to the rotation of the entire handheld electronic device. Furthermore, in the driving game context, when the user rotates the device body along a rotation axis perpendicular to the display surface to simulate steering wheel control, the display screen may remain stationary relative to the user by rotating relative to the rotation axis between the display screen and the device body along the rotation axis, thus simulating the game experience of controlling a steering wheel in the real world. Furthermore, in a driving game context, the control unit of the handheld electronic device may allow the display screen to rotate relative to the device body along the rotation axis only when the device body has a sufficiently large inclination angle relative to the horizontal plane. Therefore, when the inclination angle of the device body relative to the horizontal plane is not large enough to accurately sense the rotation angle of the device body along the rotation axis, the incorrect rotation of the display screen due to misjudgment of the rotation angle of the device body may be avoided.

What is claimed is:

1. A handheld electronic device, comprising:
a device body;
a display screen rotatably disposed on the device body along a first rotation axis and having a display surface;
a dynamic sensing unit disposed on the device body and adapted to sense an inclination angle of the display surface relative to a horizontal plane, wherein the horizontal plane is perpendicular to a direction of gravity; and
a control unit coupled to the dynamic sensing unit and the device body, wherein when the inclination angle is less than a predetermined angle, the control unit controls the device body to prohibit the display screen from rotating along the first rotation axis relative to the device body, and when the inclination angle is not less than the predetermined angle, the control unit controls the device body to allow the display screen to rotate along the first rotation axis relative to the device body.

2. The handheld electronic device of claim 1, wherein the first rotation axis is perpendicular to the display surface.

3. The handheld electronic device of claim 1, wherein the dynamic sensing unit is adapted to sense the inclination angle caused by a rotation of the display surface along a second rotation axis, and the second rotation axis is perpendicular to the first rotation axis.

4. The handheld electronic device of claim 3, wherein the display surface has two opposite long sides and two opposite short sides, and the second rotation axis is parallel to the two long sides.

5. The handheld electronic device of claim 1, wherein the predetermined angle is between 15 degrees and 20 degrees.

6. The handheld electronic device of claim 1, wherein the control unit is adapted to control the display screen to rotate 90 degrees along the first rotation axis from a standard mode to an upright mode.

7. The handheld electronic device of claim 6, wherein the device body has at least one button, and the at least one button is adapted to be pressed to trigger the standard mode or the upright mode.

8. The handheld electronic device of claim 1, wherein the control unit is adapted to switch the display screen to a driving game mode, so that when the dynamic sensing unit senses a rotation amount of the device body along the first rotation axis relative to the horizontal plane, the control unit executes a driving simulation control, and the driving simulation control controls the display screen to rotate along the first rotation axis relative to the device body according to the rotation amount, so that the display screen does not rotate along the first rotation axis relative to the horizontal plane.

9. The handheld electronic device of claim 8, wherein the device body has at least one button, and the at least one button is adapted to be pressed to trigger the driving game mode.

10. The handheld electronic device of claim 8, wherein the display surface has two opposite long sides and two opposite short sides, and when the display screen is in the driving game mode, the control unit controls the display screen to keep the two long sides parallel to the horizontal plane.

11. The handheld electronic device of claim 8, further comprising an image capture unit, wherein the image capture unit is disposed on the display device and coupled to the control unit, the image capture unit is adapted to capture a facial image of a user to obtain a facial reference axis, the display surface has two opposite long sides and two opposite short sides, and when the display screen is in the driving game mode, the control unit controls the display screen to keep the two long sides parallel to the facial reference axis.

12. The handheld electronic device of claim 11, wherein the facial reference axis is a connecting line of eyes in the facial image or a connecting line of eyebrows in the facial image.

13. The handheld electronic device of claim 8, wherein the control unit executes the driving simulation control when the rotation amount is greater than a threshold for a predetermined time length.

14. The handheld electronic device of claim 13, wherein the predetermined time length is between 10 milliseconds and 20 milliseconds.

15. The handheld electronic device of claim 1, wherein the device body comprises a body and a drive unit, the drive unit is disposed on the body and connected to the display screen, and the drive unit is coupled to the control unit and adapted to drive the display screen to rotate along the first rotation axis.

16. The handheld electronic device of claim 1, wherein the device body has two handles, a receiving groove is formed between the two handles, the receiving groove has two opposite arc-shaped inner edges, the display screen is located in the receiving groove and has two opposite arc-shaped outer edges, the two arc-shaped outer edges correspond to the two arc-shaped inner edges respectively, and when the display screen rotates along the first rotation axis relative to the device body, each of the arc-shaped outer edges slides along the arc-shaped inner edge.

17. The handheld electronic device of claim 16, wherein each of the arc-shaped inner edges is concave and each of the arc-shaped outer edges is convex.

18. The handheld electronic device of claim 16, wherein a radius of curvature of each of the arc-shaped inner edges is equal to a radius of curvature of the corresponding arc-shaped outer edge.

19. The handheld electronic device of claim 16, wherein a center of curvature of each of the arc-shaped inner edges and a center of curvature of each of the arc-shaped outer edges coincide on the first rotation axis.

20. The handheld electronic device of claim 16, further comprising at least one light-emitting unit, wherein the at least one light-emitting unit is disposed on the device body and extends along at least one of the arc-shaped inner edges.
